(19) United States
(12) Patent Application Publication
(10) Pub. No.: US 2024/0242414 A1
(43) Pub. Date: Jul. 18, 2024

(54) ELECTRONIC DEVICE AND METHOD FOR CREATING AVATAR IN VIRTUAL SPACE

(71) Applicant: SAMSUNG ELECTRONICS CO., LTD., Suwon-si (KR)

(72) Inventors: Heungryong OH, Suwon-si (KR); Donghyun SOHN, Suwon-si (KR); Jingeun PARK, Suwon-si (KR); Heekyung YANG, Suwon-si (KR)

(73) Assignee: SAMSUNG ELECTRONICS CO., LTD., Suwon-si (KR)

(21) Appl. No.: 18/519,502

(22) Filed: Nov. 27, 2023

Related U.S. Application Data
(63) Continuation of application No. PCT/KR2023/015776, filed on Oct. 12, 2023.

(30) Foreign Application Priority Data
Jan. 12, 2023 (KR) 10-2023-0005012

(51) Int. Cl. G06T 13/40; G06T 15/04; G06T 17/20; G06T 19/00

(52) U.S. Cl. CPC G06T 13/40; G06T 15/04; G06T 17/20; G06T 19/00; G06V 40/20

(57) ABSTRACT

In various embodiments, a server for managing electronic devices is provided. The server includes a memory storing instructions, and at least one processor. The at least one processor is configured to execute the instructions to obtain first image information for an object from an electronic device, obtain second image information for the object from a robot cleaner, generate avatar information for displaying an avatar of the object in a virtual space of a metaverse, based on the first image information and the second image information, and transmit the avatar information to a metaverse server for providing the virtual space of the metaverse.

### CROSS-REFERENCE TO RELATED APPLICATIONS

This application is a continuation of PCT/KR2023/015776, filed on Oct. 12, 2023, at the Korean Intellectual Property Receiving Office and claims priority under 35 U.S.C. § 119 to Korean Patent Application No. 10-2023-0005012, filed on Jan. 12, 2023, at the Korean Intellectual Property Office, the disclosures of each which are incorporated by reference herein in their entireties.

### TECHNICAL FIELD

The present disclosure relates to an electronic device and method for creating an avatar in a virtual space.

### BACKGROUND

Recently, a robot cleaner is being distributed in your home. The robot cleaner is equipped with various sensors to detect the structure of the house, and may perform cleaning automatically while moving around the house through autonomous driving technology. A method of providing various services other than simple cleaning through the various sensors mounted in the robot cleaner is being discussed.

The above-described information may be provided as a related art for the purpose of helping to understand the present disclosure. No claim or decision is raised as to whether any of the above-described contents may be applied as a prior art related to the present disclosure.

### SUMMARY

According to various embodiments, a server may include memory storing instructions and at least one processor configured to execute the instructions to obtain first image information for an object from an electronic device, obtain second image information for the object from a robot cleaner, generate avatar information for displaying an avatar of the object in a virtual space of a metaverse, based on the first image information and the second image information, and transmit the avatar information to a metaverse server for providing the virtual space of the metaverse.

According to various embodiments, a method performed by a server may include obtaining first image information for an object from an electronic device, obtaining second image information for the object from a robot cleaner, generating avatar information for displaying an avatar of the object in a virtual space of a metaverse, based on the first image information and the second image information, and transmitting the avatar information to a metaverse server for providing the virtual space of the metaverse.

According to various embodiments, a non-transitory storage medium is provided. The non-transitory storage medium may include memory configured to store instructions. The instructions cause, when executed by at least one processor, a server to obtain first image information for an object from an electronic device, obtain second image information for the object from a robot cleaner, generate avatar information for displaying an avatar of the object in a virtual space of a metaverse, based on the first image information and the second image information, and transmit the avatar information to a metaverse server for providing the virtual space of the metaverse.

### BRIEF DESCRIPTION OF THE DRAWINGS

FIG. 1 illustrates an example of a block diagram for components in a network for managing an avatar in a virtual space, according to an embodiment.

FIGS. 2A to 2B illustrate an example of a method for obtaining a user's image through a robot cleaner and a smartphone, according to an embodiment.

FIG. 3 illustrates an example of generating an avatar, according to an embodiment.

FIG. 4 illustrates an example of signaling of electronic devices, an internet of things (IoT) server, and a metaverse server for generating and managing an avatar, according to an embodiment.

FIG. 5 illustrates an example of a user interface for providing avatar information, according to an embodiment.

FIG. 6 illustrates an operation flow of an IoT server for modeling an avatar, according to an embodiment.

FIG. 7 illustrates an example of modeling a pet avatar, according to an embodiment.

FIG. 8 illustrates an operation flow of an IoT server for generating an action tree of a pet avatar, according to an embodiment.

FIGS. 9A to 9C illustrate an example of a user interface for generating a pet avatar.

### DETAILED DESCRIPTION

Hereinafter, various embodiments of the present document will be described with reference to the accompanying drawings.

The various embodiments of the present document and terms used herein are not intended to limit the technology described in the present document to specific embodiments and should be understood to include various modifications, equivalents, and/or substitutes of the embodiment. In relation to the description of the drawings, a similar reference numeral may be used for a similar component. Singular expressions may include plural expressions unless they are clearly meant differently in the context. In the present document, expressions such as “A or B”, “at least one of A and/or B”, “A, B or C”, “at least one of A, B or C”, “A, B, or C”, “at least one of A, B, or C”, or “at least one of A, B and/or C”, and the like may include all possible combinations of items listed together. As an example, the expression “at least one of A or B” includes any of the following: A, B, A and B. As an additional example, the expression “at least of A, B, or C includes any of the following: A, B, C, A and B, A and C, B and C, A and B and C. Expressions such as “1st”, “2nd”, or “the first”, or “the second”, and the like may modify the components regardless of order or importance, and are only used to distinguish one component from another, but do not limit the components. When one (e.g., first) component is referred to as being “(functionally or communicatively) connected” or “accessed” to another (e.g., second) component, the one component may be directly connected to the other component or may be connected through another component (e.g., a third component).

The term “module” used in the present document includes a unit configured with hardware, software, or firmware, and may be used interchangeably with terms such as logic, logic block, component, or circuit, and the like, for example. The module may be an integrally configured component or a minimum unit or part thereof that performs one or more functions. For example, the module may be configured with an application-specific integrated circuit (ASIC).

A term that refers to an electronic device (e.g., refrigerator, air conditioner, robotic vacuum, washer, and the like), a term that refers to the configuration of the device (e.g., processor, camera, display, module, communication circuit, and the like), a term for an operational state (e.g., step, operation, procedure), a term that refers to a signal (e.g., signal, information, data, stream, user input, input, and the like), and a term for referring to data (e.g., parameters, values, and the like) used in the following description are exemplified for convenience of description. Accordingly, the present disclosure is not limited to terms to be described later, and another term having an equivalent technical meaning may be used.

In various embodiments of the present disclosure described below, a hardware approach method will be described as an example. However, since various embodiments of the present disclosure include technology that uses both hardware and software, various embodiments of the present disclosure do not exclude a software-based approach.

In addition, in the present disclosure, in order to determine whether a specific condition is satisfied or fulfilled, an expression of more than or less than may be used, but this is only a description for expressing an example, and does not exclude description of more than or equal to or less than or equal to. A condition described as ‘more than or equal to’ may be replaced with ‘ more than’, a condition described as ‘less than or equal to’ may be replaced with ‘less than’, and a condition described as ‘more than or equal to and less than’ may be replaced with ‘more than and less than or equal to’. In addition, hereinafter, ‘A’ to ‘B’ means at least one of elements from A (including A) and to B (including B). Hereinafter, ‘C’ and/or ‘D’ means including at least one of ‘C’ or ‘D’, that is, {‘C’, ‘D’, ‘C’ and ‘D’}.

Hereinafter, in the present disclosure, the visual object may indicate an object in a virtual space corresponding to an external object of the real world. The visual object may be referred to as a character. The character may include an image or shape corresponding to the external object as a person, an animal, or an anthropomorphic object in the virtual space. For example, the visual object may include an object in the virtual space corresponding to an electronic device. The visual object may include an object in a virtual space corresponding to a user. For example, the character may include an avatar.

Recently, due to COVID-19, the transition of user's activities from offline to online is accelerating. Metaverse means a virtual world in which social, cultural, and economic activities similar to those in the real world take place, and even in the case of houses which are important in the real world, they are implemented and serviced as metaverse homes. In the current metaverse service, an avatar that replace a user plays an important role. The avatar may experience various experiences in the virtual space of the metaverse. However, in the metaverse space, it is difficult not only to accurately express the user's avatar, but also to provide the avatar for the pet of a real space in real time. Embodiments of the present disclosure relate to a device and method for displaying the avatar corresponding to the user or the pet in the virtual space, through a robot cleaner, in an immersive service platform, such as the metaverse service.

In the present disclosure, a technology for generating an avatar having a similar appearance to the user or pet of the real space through a smartphone and the robot cleaner equipped with various sensors is described. In addition, in the present disclosure, by recognizing the action patterns of pets of the real space through the robot cleaner equipped with the various sensors and applying the action patterns to the pet avatars in the virtual space of the metaverse, the pet avatars may have action patterns similar to those in the real space.

The metaverse is a compound word of the English word ‘Meta’, which means “virtual” and “transcendence,” and ‘Universe’, which means the universe, and refers to a three-dimensional virtual world where social, economic, and cultural activities such as the real world take place. The metaverse is a concept that has evolved one step further than virtual reality (VR, a state-of-the-art technology that allows people to experience the same as real life in a virtual world created by a computer), and is characterized by being able to use avatars to engage in social and cultural activities like real life rather than just enjoying games or virtual reality. The metaverse service may provide media content for enhancing immersion for the virtual world, based on augmented reality (AR), virtual reality environment (VR), mixed environment (MR) and/or extended reality (XR).

For example, the media content provided by the metaverse service may include social interaction content including avatar-based games, concerts, parties, and/or conferences. For example, the media content may include advertising, user created content, and/or information for economic activities such as sales of products and/or shopping. The ownership of the user created content may be proved by a blockchain-based non-fungible token (NFT). The metaverse service may support economic activities based on real money and/or cryptocurrency. By the metaverse service, virtual content linked to the real world, such as a digital twin or life logging, may be provided.

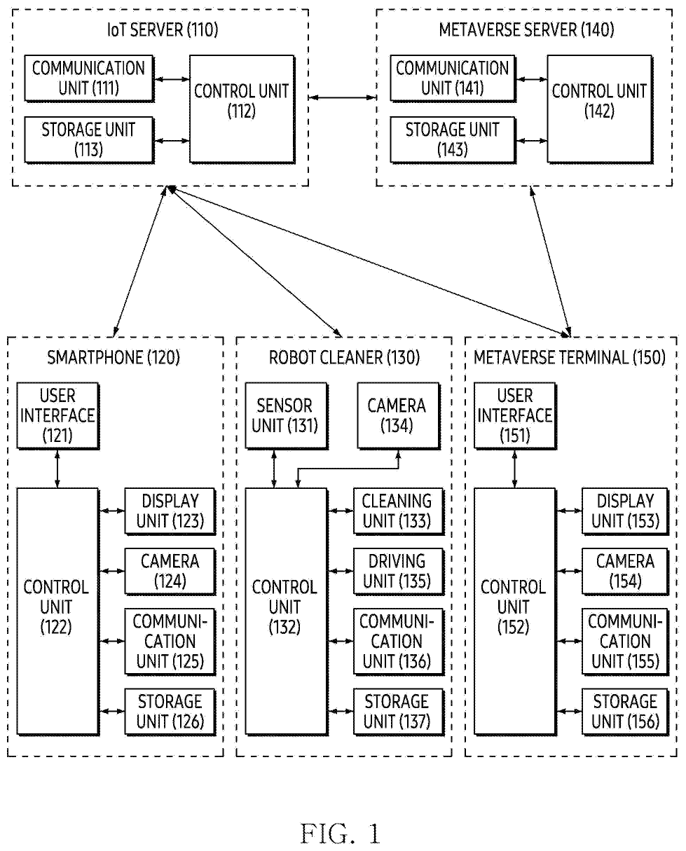

FIG. 1 illustrates an example of a block diagram for components in a network for managing an avatar in a virtual space, according to an embodiment. Terms such as ‘ . . . unit’, ‘ . . . er’, and the like used below mean a unit that processes at least one function or operation, and may be implemented by hardware, software, or a combination of hardware and software.

In the present disclosure, operations for a server for managing a plurality of electronic devices are described. In the present disclosure, the server is described as one network device, but is not limited thereto. The server may be configured with one or a plurality of physical hardware devices. For example, the server may be configured such that a plurality of hardware devices are virtualized to perform one logical function. For example, the server may include one or more devices that perform cloud computing. Electronic devices managed by the server may include one or more IoT devices. In this case, the server may include an IoT server.

Referring to FIG. 1, a system for displaying an avatar in a virtual space of a metaverse may include an IoT server 110, a smartphone 120, a robot cleaner 130, a metaverse server 140, and a metaverse terminal 150. According to an embodiment, the IoT server 110 may include a communication unit 111, a control unit 112, and a storage unit 113. The IoT server 110 may include network equipment for managing a plurality of IoT devices. The communication unit 111 may transmit and receive a signal. The communication unit 111 may include at least one transceiver. The communication unit 111 may perform communication with one or more devices. For example, the communication unit 111 may perform communication with the electronic devices (e.g., the smartphone 120 and the robot cleaner 130). Although the smartphone 120 and the robot cleaner 130 are illustrated in FIG. 1, embodiments of the present disclosure are not limited thereto. The communication unit 111 may perform communication with other electronic devices such as a tablet, PC, and TV as well as the smartphone 120 and the robot cleaner 130.

The control unit 112 controls overall operations of the IoT server 110. The control unit 112 may include at least one processor or microprocessor, or may be a part of the processor. The control unit 112 may include various modules for performing operations of the IoT server 110. For example, the control unit 112 may include an authentication module. For example, the control unit 112 may include a message module. For example, the control unit 112 may include a device management module. For example, the control unit 112 may include an information analysis module. According to an embodiment, the control unit 112 may generate avatar information on an object (e.g., a user and a pet) and may analyze the action pattern of the object, based on data collected from the electronic devices (e.g., the smartphone 120 and the robot cleaner 130).

The storage unit 113 stores data such as a basic program, an application program, and setting information for the operation of the IoT server 110. The storage unit 113 may be configured with a volatile memory, a nonvolatile memory, or a combination of a volatile memory and a nonvolatile memory. In addition, the storage unit 113 provides the stored data according to the request of the control unit 112. The storage unit 113 may store data collected from one or more devices connected to the IoT server 110. For example, the storage unit 113 may store user information. For example, the storage unit 113 may store device information. For example, the storage unit 113 may store service information. For example, the storage unit 113 may store sensor information.

According to an embodiment, the smartphone 120 may include a user interface 121, a control unit 122, a display unit 123, a camera 124, a communication unit 125, and a storage unit 126. The user interface 121 may include an interface for processing a user input of the smartphone 120. For example, the user interface 121 may include a microphone. For example, the user interface 121 may include an input unit. For example, the user interface 121 may include a speaker. For example, the user interface 121 may include a haptic unit.

The control unit 122 controls overall operations of the smartphone 120. The control unit 122 may include at least one processor or microprocessor, or may be a part of the processor. The control unit 122 may control the display unit 123, the camera 124, the communication unit 125, and the storage unit 126. The display unit 123 may visually provide information to the outside (e.g., the user) of the smartphone 120. The camera 124 may capture a still image and a moving image. According to an embodiment, the camera 124 may include one or more lenses, image sensors, image signal processors, or flashes. The communication unit 125 may support the establishment of a direct (e.g., wired) communication channel or wireless communication channel between external electronic devices (e.g., the IoT server 110), and the performance of communication through the established communication channel. The storage unit 126 may store various data used by at least one component of the smartphone 120. For example, the storage unit 126 may further include information for a metaverse service (e.g., a metaverse service enabler).

According to an embodiment, the robot cleaner 130 may include a sensor unit 131, a control unit 132, a cleaning unit 133, a camera 134, a driving unit 135, a communication unit 136, and a storage unit 137. The sensor unit 131 may measure and collect data through various sensors. For example, the sensor unit 131 may include a microphone. For example, the sensor unit 131 may include a light detection and ranging (LiDAR). For example, the sensor unit 131 may include a temperature sensor. For example, the sensor unit 131 may include a dust sensor. For example, the sensor unit 131 may include an illuminance sensor.

The control unit 132 controls overall operations of the robot cleaner 130. The control unit 132 may include at least one processor or microprocessor, or may be a part of the processor. The control unit 132 may control the cleaning unit 133, the camera 134, the driving unit 135, the communication unit 136, and the storage unit 137. The cleaning unit 133 may include a cleaning tool to be executed according to a command of the control unit 132. For example, the cleaning unit 133 may include a brush unit. For example, the cleaning unit 133 may include a suction unit. The camera 134 may capture a still image and a moving image. According to an embodiment, the camera 134 may include one or more lenses, image sensors, image signal processors, or flashes. The camera 134 may include various types of cameras (e.g., a red green blue (RGB) camera and a 3-dimensional (3D) depth camera). The driving unit 135 may include means of transportation for moving the robot cleaner 130 along a designated path. The communication unit 136 may support the establishment of a direct (e.g., wired) communication channel or wireless communication channel between external electronic devices (e.g., the IoT server 110), and the performance of communication through the established communication channel. The storage unit 137 may store various data used by at least one component of the robot cleaner 130. For example, the storage unit 137 may further include information for a metaverse service (e.g., a metaverse service enabler).

According to an embodiment, the metaverse server 140 may include a communication unit 141, a control unit 142, and a storage unit 143. The metaverse server 140 may mean equipment for managing a virtual space of a metaverse of the metaverse terminal 150. The metaverse server 140 may provide rendering information to the metaverse terminal 150 so that the virtual space may be displayed on the metaverse terminal 150.

The communication unit 141 may transmit and receive a signal. The communication unit 141 may include at least one transceiver. The communication unit 141 may perform communication with one or more devices. For example, the communication unit 141 may perform communication with the IoT server 110. For example, the communication unit 141 may perform communication with a user using the virtual space, that is, the metaverse terminal 150.

The control unit 142 controls overall operations of the metaverse server 140. The control unit 142 may include at least one processor or microprocessor, or may be a part of the processor. The control unit 142 may include various modules for performing operations of the metaverse server 140. For example, the control unit 142 may include an authentication module. For example, the control unit 142 may include a rendering module. For example, the control unit 142 may include a video encoding module. For example, the controller 142 may include an engine processing module.

The storage unit 143 stores data such as a basic program, an application program, and setting information for the operation of the metaverse server 140. The storage unit 143 may be configured with a volatile memory, a nonvolatile memory, or a combination of a volatile memory and a nonvolatile memory. In addition, the storage unit 143 provides the stored data according to the request of the control unit 142. The storage unit 143 may store data necessary for displaying the avatar in the virtual space. For example, the storage unit 143 may store user information. For example, the storage unit 143 may store avatar information. For example, the storage unit 143 may store spatial information. For example, the storage unit 143 may store object information. For example, the storage unit 143 may store service information.

According to an embodiment, the metaverse terminal 150 may include a user interface 151, a control unit 152, a display unit 153, a camera 154, a communication unit 155, and a storage unit 156. The user interface 151 may include an interface for processing a user input of the metaverse terminal 150. For example, the user interface 151 may include a microphone. For example, the user interface 151 may include an input unit. For example, the user interface 151 may include a speaker. For example, the user interface 151 may include a haptic unit.

The control unit 152 controls overall operations of the metaverse terminal 150. The control unit 152 may include at least one processor or microprocessor, or may be a part of the processor. The control unit 152 may control the display unit 153, the camera 154, the communication unit 155, and the storage unit 156. The display unit 153 may visually provide information to a user of the metaverse terminal 150. For example, the display unit 153 may visually provide the virtual space of the metaverse to the user through one or more displays. The camera 154 may capture a still image and a moving image. According to an embodiment, the camera 154 may include one or more lenses, image sensors, image signal processors, or flashes. The communication unit 155 may support the establishment of a direct (e.g., wired) communication channel or wireless communication channel between external electronic devices (e.g., the IoT server 110 and the metaverse server 140), and the performance of communication through the established communication channel. The storage unit 156 may store various data used by at least one component of the metaverse terminal 150. For example, the storage unit 156 may further include information for a metaverse service (e.g., a metaverse service enabler).

According to an embodiment, the robot cleaner 130 may capture an image of the pet through the camera 134. The robot cleaner 130 may provide the image of the pet to the IoT server 110. The smartphone 120 may provide inputted information (e.g., breed, age, weight, and gender) on the pet to the IoT server 110. The IoT server 110 may store the information on the pet through the storage unit 113. The IoT server 110 may generate the avatar information based on the information on the pet and the image of the pet. The IoT server 110 may provide the avatar information to the metaverse server 140. The metaverse server 140 may store the avatar information through the storage unit 143. The metaverse server 140 may transmit an image for displaying an avatar (hereinafter, referred to as a pet avatar) corresponding to the pet to the metaverse terminal 150. The metaverse terminal 150 may receive the image for displaying the pet avatar. The metaverse terminal 150 may display the pet avatar in the virtual space based on the received image.

In FIG. 1, a functional configuration of an electronic device in a system has been described, but embodiments of the present disclosure are not limited thereto. The components illustrated in FIG. 1 are exemplary, and at least some of the components illustrated in FIG. 1 may be omitted or other components may be added. For example, the robot cleaner 130 may further include a display unit. In addition, for another example, the robot cleaner 130 may not include an illuminance sensor. In addition, in an exemplary embodiment, the smartphone 120 and the metaverse terminal 150 are separately illustrated for convenience of description, but the embodiments of the present disclosure are not limited to these illustrations. According to an embodiment, the smartphone 120 and the metaverse terminal 150 may be configured as one terminal.

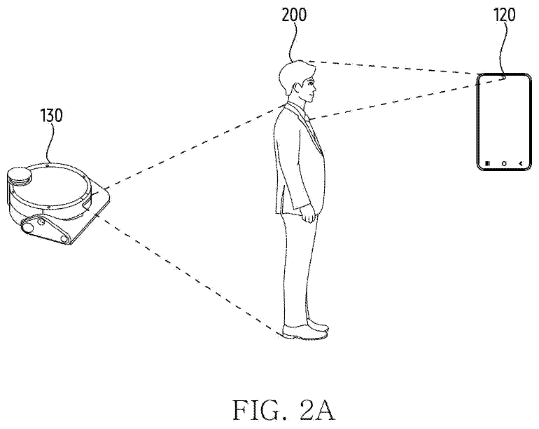

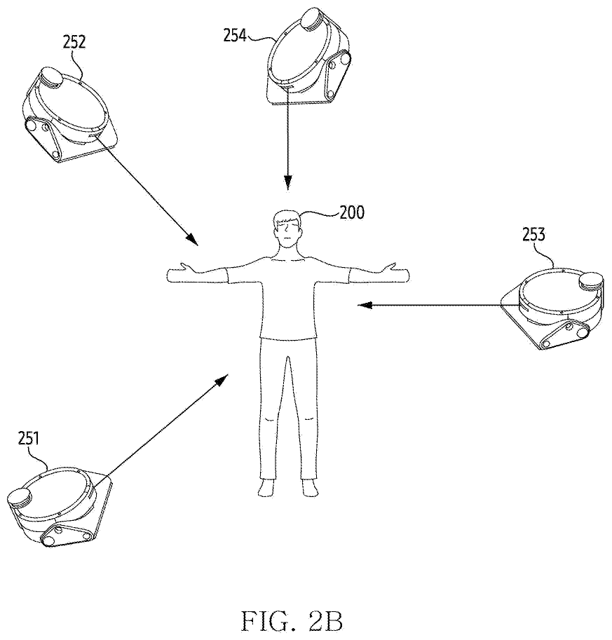

FIGS. 2A to 2B illustrate an example of a method for obtaining a user's image through a robot cleaner (e.g., a robot cleaner 130) and a smartphone (e.g., a smartphone 120), according to an embodiment. Avatars using existing smart phones were generated limited to the user's face part or the user's upper body part, so they were not suitable for avatars in the metaverse space. In order to solve the above-described problem, the user's avatar may be generated by a combination of the smartphone 120 and the robot cleaner 130.

Referring to FIG. 2A, the smartphone 120 may capture an image of a user 200. For example, the smartphone 120 may obtain the image of the user 200 in response to the user 200's input or execution of an application. The image of the user 200 may include at least a partial area (e.g., upper body, face part) of the user's body. The smartphone 120 may generate first image information including the image of the user 200. The smartphone 120 may provide the first image information to an external server (e.g., an IoT server 110). The first image information may be used to generate a user's avatar in a virtual space.

The robot cleaner 130 may obtain the image of the user 200. The robot cleaner 130 may detect the user 220. For example, the robot cleaner 130 may recognize a 3D object by using various sensors (e.g., a sensor unit 131, LiDAR, and the like). When the user 220 is detected, the robot cleaner 130 may initiate capturing. For example, since the robot cleaner 130 is capable of autonomous driving by itself, it may be used to generate a full-body 3D avatar. The robot cleaner 130 may recognize the position of the robot cleaner 130 and the user's position on the generated in-home map.

Referring to FIG. 2B, the robot cleaner 130 may perform capturing at various positions (e.g., a first position 251, a second position 252, a third position 253, and a fourth position 254) with the user's surrounding as a center. According to an embodiment, in an avatar modeling process, when the image of the user 200 in a specific direction is necessary, the robot cleaner 130 may perform the autonomous driving. The robot cleaner 130 may move to the user's surrounding and then proceed with capturing. The robot cleaner 130 may determine the capturing direction from each image of the user 200, by analyzing the image of the object obtained at each position. Thereafter, the robot cleaner 130 may determine the capturing direction necessary for generating the avatar, and then may find the user 200 through the autonomous driving. When the user 200 is detected, the robot cleaner 130 may capture the user 200 in various directions while moving around the user 200.

For example, the robot cleaner 130 may calculate a space (blue circle) necessary for 360-degree capturing. The robot cleaner 130 may guide the user to move to a space necessary for capturing. For example, the robot cleaner 130 may provide a guide to the user, such as, “For avatar generation, please move 1 m away from the obstacle.”. When the 3D depth camera detects the user at the corresponding position, the robot cleaner 130 may capture the image of the user 200 while rotating at 360 degrees. The image of the user 200 may include at least a partial area (e.g., lower body, torso part, and leg part) of the user's body. The robot cleaner 130 may generate second image information including the image of the user 200. The robot cleaner 130 may provide the second image information to the external server (e.g., the IoT server 110). The second image information may be used to generate the user's avatar in the virtual space. For example, the IoT server 110 may generate the avatar corresponding to the user in the virtual space such as the metaverse, by using the smartphone 120 and the robot cleaner 130.

In FIGS. 2A to 2B, the smartphone 120 and the robot cleaner 130 for capturing the user 200 are illustrated, but the embodiments of the present disclosure are not limited thereto. Embodiments of the present disclosure may be used to capture not only the user 200 but also a companion animal in a real space, that is, a pet, and to express an avatar corresponding to the pet in the virtual space. For example, the smartphone 120 may obtain a first image of the pet with respect to the viewpoint viewed from a higher position than the pet. The robot cleaner 130 may obtain a second image of the pet with respect to the viewpoint where the pet is viewed, on the ground where the pet is positioned. For example, in case that the pet image from the front is obtained and the pet image from the side is obtained, but the pet image from the back is not obtained, the robot cleaner 130 may determine that the rear direction capturing is necessary through image analysis. The IoT server 110 may generate the avatar corresponding to the pet in the virtual space, by using the smartphone 120 and the robot cleaner 130.

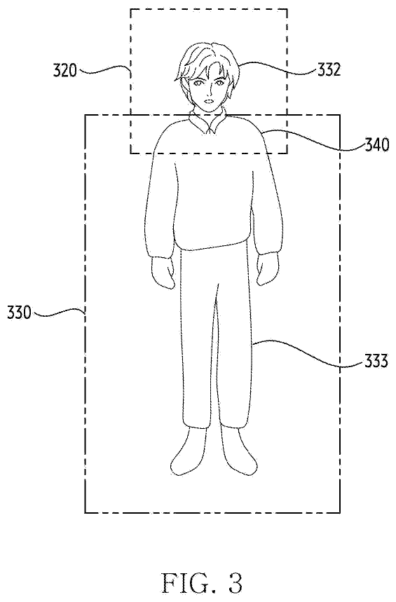

FIG. 3 illustrates an example of generating an avatar, according to an embodiment. The avatar may be generated based on first image information obtained through a smartphone (e.g., a smartphone 120) and second image information obtained through a robot cleaner (e.g., a robot cleaner 130).

Referring to FIG. 3, a first area 320 is an area captured through the smartphone 120. An IoT server (e.g., an IoT server 110) may generate avatar information for the first area 320 based on the first image information. The IoT server (e.g., the IoT server 110) may generate the avatar information so that rendering of an upper body part 332 of the avatar corresponding to the first area 320 is possible. The rendering may be performed by a metaverse server (e.g., a metaverse server 140) that has received the avatar information. A second area 330 is an area captured through the robot cleaner 130. The IoT server 110 may generate the avatar information for the second area 330 based on the second image information. The IoT server 110 may generate the avatar information so that rendering of a torso part 333 of the avatar corresponding to the second area 330 is possible.

For rendering of an area where the first area 320 and the second area 330 overlap, that is, a third area 340, the IoT server 110 may generate the avatar information based on at least one of the first image information and the second image information. For example, the IoT server 110 may generate avatar information for rendering of the third area 340 based on the first image information. The priority of image information for the smartphone 120 may be higher than the priority of image information for the robot cleaner 130. In addition, for example, the IoT server 110 may generate the avatar information for rendering of the third area 340 based on the second image information. The priority of the image information for the smartphone 120 may be lower than the priority of the image information for the robot cleaner 130. In addition, for example, the IoT server 110 may generate the avatar information for rendering based on a combination of the first image information and the second image information. The IoT server 110 may generate the avatar information based on a weight for the smartphone 120 and a weight for the robot cleaner 130. The weight for the smartphone 120 may be applied to the first image information. The weight for the robot cleaner 130 may be applied to the second image information.

In FIG. 3, a situation in which the IoT server 110 generates the avatar information based on the image information collected from the smartphone 120 and the robot cleaner 130 and provides the generated avatar information to the metaverse server 140 was described, but the embodiments of the present disclosure are not limited thereto. According to another embodiment, the IoT server 110 provides the collected image information to the metaverse server 140, and the avatar information may be directly generated in the metaverse server 140.

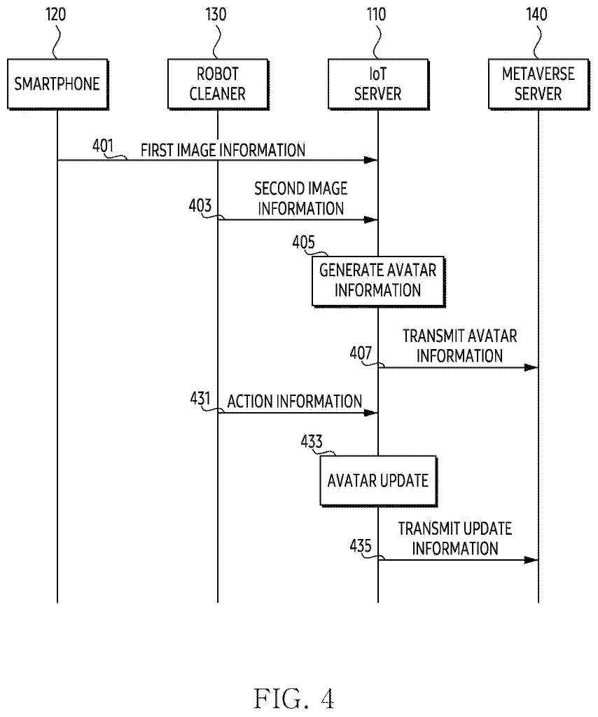

FIG. 4 illustrates an example of signaling of electronic devices (e.g., a smartphone 120 and a robot cleaner 130) for generating and managing an avatar, an IoT server (e.g., an IoT server 110), and a metaverse server (e.g., a metaverse server 140), according to an embodiment. An object in a real space may correspond to an avatar in a virtual space of a metaverse. For example, the object may be a user. In addition, for example, the object may be a pet. An avatar corresponding to the user may be referred to as a user avatar, and an avatar corresponding to the pet may be referred to as a pet avatar.

Referring to FIG. 4, in operation 401, the smartphone 120 may transmit first image information to the IoT server 110. The smartphone 120 may transmit the first image information to the IoT server 110 through a wireless connection. The first image information may include at least one image obtained through the smartphone 120. The smartphone 120 may obtain an image of the object through a camera (e.g., a camera 124) mounted on the smartphone 120. For example, the first image information may include at least one image of at least a part (e.g., upper body) of the user's body. In addition, for example, the first image information may include at least one image of at least a part of the pet's body. In addition, for example, the first image information may include at least one image obtained by capturing the pet at a point higher than the pet through the smartphone 120.

In operation 403, the robot cleaner 130 may transmit second image information to the IoT server 110. The robot cleaner 130 may transmit the second image information to the IoT server 110 through the wireless connection. The second image information may include at least one image obtained through the robot cleaner 130. The robot cleaner 130 may obtain the image of the object through a camera (e.g., a camera 134) mounted on the robot cleaner 130. For example, the second image information may include at least one image of at least a part (e.g., lower body, torso) of the user's body. In addition, for example, the second image information may include at least one image of at least a part of the pet's body, obtained through the robot cleaner 130. In addition, for example, the second image information may include at least one image obtained by capturing the pet in a direction of looking at the pet at the ground where the pet is positioned, through the robot cleaner 130.

In operation 405, the IoT server 110 may generate avatar information. The avatar information may include data necessary for displaying the avatar in the virtual space (e.g., the virtual space). The IoT server 110 may collect data from a plurality of devices (e.g., the smartphone 120 and the robot cleaner 130) connected to the IoT server 110. The IoT server 110 may generate avatar information for the object based on the collected data. For example, the IoT server 110 may generate the avatar information for the object based on the first image information and the second image information.

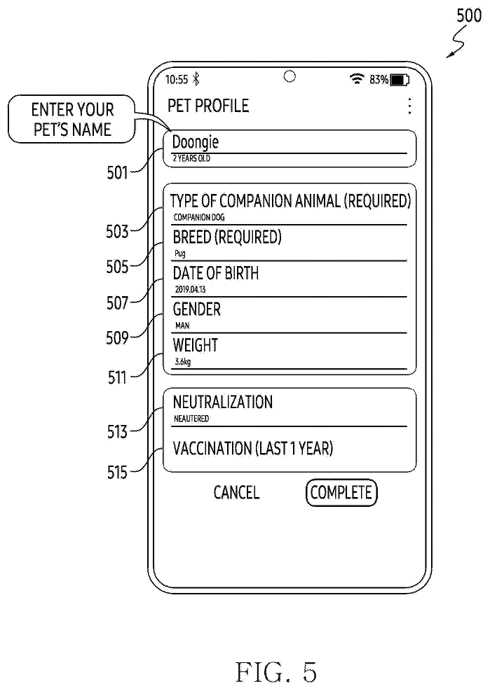

According to an embodiment, the avatar information may include avatar appearance information and texture information. The avatar appearance information may be information for forming an avatar mesh. For example, the IoT server 110 may generate the avatar appearance information corresponding to the object in the real space based on the object-related information. For example, the IoT server 110 may obtain the object-related information from an external electronic device (e.g., the smartphone 120). The object-related information may include prior information (e.g., weight, height, name, and breed) on an object (e.g., the pet) that is a target of the avatar. In addition, according to an embodiment, the IoT server 110 may generate the avatar appearance information corresponding to the object in the real space, based on object image information (e.g., at least one of the first image information or the second image information). In addition, according to an embodiment, the IoT server 110 may generate the avatar appearance information, based on a combination of the object-related information and the object image information. For example, an appearance generated through the object-related information may be supplemented through the object image information. Description of the object-related information will be described in detail through FIG. 5.

The IoT server 110 may generate the texture information, based on the object image information (e.g., the first image information and the second image information) for the object. The texture information may include features such as a design, pattern, texture, or color of the object in addition to the appearance. The avatar in the virtual space may be generated by applying the texture information to the appearance of the avatar appearance information.

According to an embodiment, the avatar information may include first avatar information for a first area of the object and second avatar information for a second area of the object. The first area of the object may include an area where the image of the object is captured according to the first image information of operation 401. The second area of the object may include an area where the image of the object is captured according to the second image information of operation 402. Since the smartphone 120 and the robot cleaner 130 capture objects at different positions, respectively, areas of the objects may be different in the captured images. For example, as illustrated in FIG. 3, the first area may include the upper body of the object. The second area may include the lower body of the object. The IoT server 110 may generate the first avatar information for rendering in a virtual space area corresponding to the first area, based on the first image information. The IoT server 110 may generate the second avatar information for rendering in a virtual space area corresponding to the second area, based on the second image information.

Meanwhile, the first area and the second area may overlap each other. In this case, the overlapping area may be referred to as a third area. The IoT server 110 may use at least one of the first image information and the second image information for rendering in a virtual space area corresponding to the third area. For example, the IoT server 110 may generate third avatar information for rendering in the virtual space area corresponding to the third area based on the first image information. In addition, for example, the IoT server 110 may generate the third avatar information for rendering in the virtual space area corresponding to the third area based on the second image information. In addition, for example, the IoT server 110 may generate the third avatar information for rendering in the virtual space area corresponding to the third area based on the first image information and the second image information.

In case that the avatar is displayed on the virtual space corresponding to the third area by combining the first image information and the second image information, a first weight and a second weight may be applied. The first weight may be applied to the first image information obtained through the smartphone 120. The second weight may be applied to the second image information obtained through the robot cleaner 130. For example, the second weight may be set higher than the first weight. For example, the robot cleaner 130 may obtain the images of the object at a plurality of positions, through 360-degree capturing. Meanwhile, the smartphone 120 is not easy to obtain various images when capturing the image of the object due to the limitations of a front camera or a rear camera. As the second weight is set higher than the first weight, accurate information on the 3D object may be reflected. For another example, the first weight may be set higher than the second weight. The image of the pet avatar in the virtual space may be displayed as a perspective on the user in the metaverse space. In order to further enhance user experience, the first weight for the smartphone 120 directly related to the user's field of view may be set higher than the second weight for the robot cleaner 130.

In operation 407, the IoT server 110 may transmit the avatar information to the metaverse server 140. The IoT server 110 may transmit the avatar information to the metaverse server 140 through a communication network. The metaverse server 140 may perform rendering for displaying the avatar in the virtual space of the metaverse based on the avatar information received from the IoT server 110. The metaverse server 140 may generate rendering information for displaying the avatar. The metaverse server 140 may provide the rendering information to a metaverse terminal (e.g., a metaverse terminal 150). Through the rendering information, the metaverse terminal 150 may display an avatar of the object in the virtual space.

In operations 401 to 407, an example for generating the avatar corresponding to the object (e.g., the user and the pet) in the real space within the virtual space has been described. Meanwhile, in the real space, an object having mobility, such as the user or the pet, may move in real time. Therefore, in order to express the movement of the avatar in the virtual space, the IoT server 110 is required to monitor the action of the object in real time. For example, the robot cleaner 130 may provide action information to the IoT server 110 in case of detecting an object's action in the real space. The action information may be used by the avatar to perform the same or similar action as the object in the virtual space of the metaverse.

In operation 431, the robot cleaner 130 may transmit the action information to the IoT server 110. According to an embodiment, the robot cleaner 130 may detect and track the object. In case that motion (e.g., movement, action) of a designated object (e.g., user, pet) is detected, the robot cleaner 130 may generate action information on the designated object. The IoT server 110 may obtain the action information from the robot cleaner 130. The IoT server 110 may analyze the obtained action information.

In operation 433, the IoT server 110 may perform an avatar update. The IoT server 110 may update avatar information corresponding to the object based on the analysis of the action information on the object. The avatar update may include a change in the state of the avatar corresponding to the action of the object. For example, in case that the object moves in the real space, the IoT server 110 may perform the update on the avatar information so that the avatar moves in the virtual space. In addition, for example, in case that the attitude of the object changes in the real space, the IoT server 110 may perform the update on the avatar information so that the attitude of the avatar changes in the virtual space. In addition, for example, in case that the object performs a specific action in the real space, the IoT server 110 may perform the update on the avatar information so that the avatar performs an operation corresponding to the specific action in the virtual space. The IoT server 110 may generate update information through the update on the avatar information.

In operation 435, the IoT server 110 may transmit the update information to the metaverse server 140. Based on the update information, the metaverse server 140 may transmit rendering information in which the state of the avatar is changed to the metaverse terminal 150. The changed state of the avatar may correspond to the action of the object detected in the real space. For example, in case that the object moves in the real space, the avatar may move in the virtual space. For example, in case that the attitude of the object is changed in the real space, the attitude of the avatar may be changed in the virtual space. For example, in case that the object performs the specific action in the real space, the avatar may perform an operation corresponding to the specific action in the virtual space.

According to an embodiment, operations 431 to 435 may be used to reflect the pet avatar in the virtual space. The robot cleaner 130 may collect the action information. For example, the robot cleaner 130 may capture the image of the pet through the camera 134. For example, the robot cleaner 130 may obtain a voice of the pet through a microphone of the sensor unit 131. For example, the robot cleaner 130 may measure the temperature around the pet. The robot cleaner 130 may provide the action information to the IoT server 110. The IoT server 110 may generate update information for reflecting the changed action information of the pet. The IoT server 110 may provide the update information to the metaverse server 140. In addition, the IoT server 110 may analyze the action information of the pet through an information analysis module in the control unit 112. The IoT server 110 may generate an action pattern through an analysis result of the action information of the pet. The IoT server 110 may provide the generated pattern information to the metaverse server 140. The metaverse server 140 may store the information provided from the IoT server 110 as the avatar information through a storage unit 143. The metaverse server 140 may transmit an image for displaying the changed action of the pet avatar to the metaverse terminal 150. The metaverse terminal 150 may receive an image for displaying the pet avatar. The metaverse terminal 150 may display the action of the pet avatar in the virtual space based on the received image. In addition, the metaverse server 140 may render the pet avatar to act in response to a designated user action in the virtual space according to the generated pattern information. The metaverse server 140 may render the changed image of the pet avatar so that the pet avatar performs an action corresponding to the motion of the user of the metaverse terminal 150. The metaverse server 140 may provide the rendered image to the metaverse terminal 150.

As illustrated in FIG. 4, avatar modeling may be performed through the smartphone 120 and the robot cleaner 130. Additionally, since the robot cleaner 130 is movable, the information on the object (e.g., the user, the pet) may be continuously obtained. For example, the robot cleaner 130 may be configured to detect the action pattern or real-time action of the object. Based on the data collected from the robot cleaner 130, the action of the avatar may be determined, and through this, the experience with the object may be shared even in the virtual space such as the metaverse.

FIG. 5 illustrates an example of a user interface for providing avatar information, according to an embodiment. In FIG. 5, in order to display a pet avatar in a virtual space, an example of input of prior information related to a pet in a real space, that is, object-related information, is described.

Referring to FIG. 5, a user interface 500 may be provided through a display (e.g., a display unit 123) of a smartphone 120. The user of smartphone 120 may input the prior information on the user's pet on the user interface 500.

The user interface 500 may include items for inputting the prior information. For example, the user interface 500 may include a first visual object 501 for inputting the name of the pet. In addition, for example, the user interface 500 may include a second visual object 503 for inputting the type of the pet (e.g., a companion dog). In addition, for example, the user interface 500 may include a third visual object 505 for inputting the breed of the pet. In addition, for example, the user interface 500 may include a fourth visual object 507 for inputting the date of birth of the pet. In addition, for example, the user interface 500 may include a fifth visual object 509 for inputting the gender of the pet. In addition, for example, the user interface 500 may include a sixth visual object 511 for inputting the weight of the pet. In addition, for example, the user interface 500 may include a seventh visual object 513 for inputting whether or not the pet is neutered. In addition, for example, the user interface 500 may include an eighth visual object 515 for inputting whether or not the pet is vaccinated.

As illustrated in FIG. 5, the object-related information inputted from the smartphone 120 may be used to generate an avatar in the virtual space. For example, the object-related information may be used to determine an appearance of the avatar to be displayed in the virtual space. For example, the appearance of the avatar corresponding to the gender, type, and weight of the object-related information may be determined. The smartphone 120 may transmit information inputted through the user interface 500, that is, the object-related information, to the IoT server 110. The IoT server 110 may store the received object-related information. For example, the storage unit 113 of the IoT server 110 may store the object-related information. The IoT server 110 may generate the avatar information based on the received object-related information. The IoT server 110 may generate the avatar information based on the object-related information as well as the image (e.g., first image information) captured through the smartphone 120 or the image (e.g., second image information) captured through the robot cleaner 130. The avatar information may include detail information corresponding to the object-related information. The detail information may mean texture information for expressing a design, color, pattern, or texture of an object. For example, in case that the breed of the inputted pet is a poodle, the IoT server 110 may generate the avatar information by combining the first image information and the second image information with existing image appearance information for the poodle. In addition, for example, in case that the age of the inputted pet is 10 years or older, the IoT server 110 may generate avatar information including processing for wrinkles or skin on the pet's avatar.

The object-related information may be used by the robot cleaner 130 to capture an image of the object. According to an embodiment, the object-related information registered in the IoT server 110 may be provided to the robot cleaner 130. The robot cleaner 130 may be configured to capture the object (e.g., the pet) corresponding to the object-related information. For example, the robot cleaner 130 may identify a pet corresponding to the object-related information by using a built-in camera (e.g., a camera 134). The robot cleaner 130 may capture the identified pet. The robot cleaner 130 may capture the pet in various situations. For example, the robot cleaner 130 may capture the pet, in the process of performing cleaning. For another example, the robot cleaner 130 may search for the pet and capture the pet while autonomously driving around the house by a user's control (e.g., a control command from a user terminal (e.g., the smartphone 120)). For still another example, the robot cleaner 130 may capture the pet while moving around the house, in an operation mode performing a function which is different from cleaning, such as a crime prevention mode.

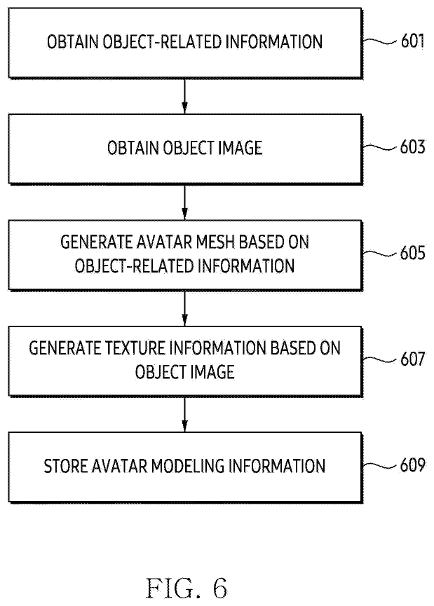

FIG. 6 illustrates an operation flow of an IoT server (e.g., an IoT server 110) for modeling an avatar, according to an embodiment.

Referring to FIG. 6, in operation 601, the IoT server 110 may obtain object-related information. The object-related information may include prior information on an object corresponding to the avatar. The IoT server 110 may obtain the prior information on the object from the user's electronic device (e.g., a smartphone 120). For example, the IoT server 110 may obtain information (e.g., height and weight) on an appearance of the object. For example, the IoT server 110 may obtain information on the age of the object. For example, the IoT server 110 may obtain information on the identity of object (e.g., breed of the pet, type of the pet). For example, the IoT server 110 may obtain information on the health state of the object.

In operation 603, the IoT server 110 may obtain an object image. The object image may include an image captured for at least a part of the object. According to an embodiment, the IoT server 110 may obtain first image information from a smartphone (e.g., the smartphone 120). The first image information may include at least one image of at least a part of the object. For example, the first image information may include at least one image of the upper body or face part of the object (e.g., the user). In addition, for example, the first image information may include at least one image obtained by capturing the object (e.g., the pet) above the object. In addition, according to an embodiment, the IoT server 110 may obtain second image information from a robot cleaner (e.g., a robot cleaner 130). The second image information may include at least one image of at least a part of the object. For example, the second image information may include at least one image of the lower body or torso and leg part of the object (e.g., the user). In addition, for example, the second image information may be at least one image obtained by capturing the object (e.g., the pet) on the ground.

In order to display an object in a real space as an avatar in the virtual space, the IoT server 110 may generate avatar information. The avatar information may be used for rendering in a metaverse server (e.g., a metaverse server 140). For example, the avatar information may include an avatar mesh corresponding to the appearance of the avatar. In addition, for example, the avatar information may include texture information for expressing a texture of a real object in the virtual space.

In operation 605, the IoT server 110 may generate the avatar mesh based on the object-related information. The IoT server 110 may determine the appearance of the object based on the object-related information. For example, the IoT server 110 may determine the user's appearance based on height, weight, gender, and appearance information. In addition, for example, the IoT server 110 may determine the appearance of the pet based on the type, breed, age, and gender of the pet. The IoT server 110 may generate the avatar mesh based on the appearance.

In operation 607, the IoT server 110 may generate the texture information based on the object image. The texture information may include information on a design, pattern, color, or texture to be applied to the appearance of the avatar. Based on the object image, the IoT server 110 may identify features such as the design, pattern, color, or texture corresponding to objects in the real space. The IoT server 110 may generate the texture information corresponding to the identified features. For example, the IoT server 110 may generate the texture information based on the first image information. For another example, the IoT server 110 may generate the texture information based on the second image information. For still another example, the IoT server 110 may generate the texture information based on the first image information and the second image information. In case that both the first image information and the second image information are used, a first weight may be applied to the first image information and a second weight may be applied to the second image information.

In operation 609, the IoT server 110 may store avatar modeling information. The stored avatar modeling information may be provided to the metaverse server 140. The avatar modeling information may be used for rendering in the virtual space of the metaverse server 140. The IoT server 110 may apply the generated texture information to the avatar mesh. The avatar modeling information may be stored as service information.

In FIG. 6, an example of determining the avatar mesh, that is, the appearance of the avatar, based on the object-related information has been described, but embodiments of the present disclosure are not limited thereto. The avatar mesh may be generated based on the object-related information and the object image. In order to more accurately obtain the appearance of the object, the IoT server 110 may generate the avatar mesh by combining the object-related information, the images obtained through the robot cleaner 130, and the images obtained through the smartphone 120.

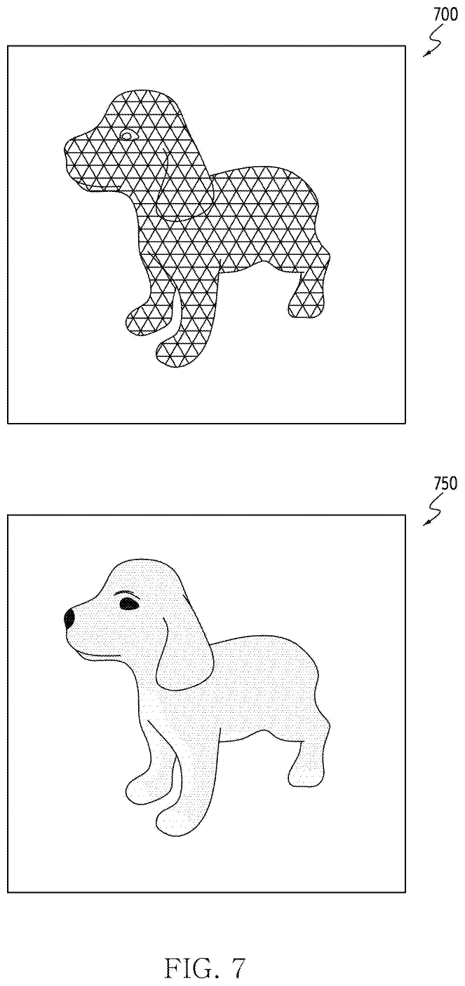

FIG. 7 illustrates an example of modeling a pet avatar, according to an embodiment.

Referring to FIG. 7, an avatar mesh 700 may be generated based on object-related information on a pet. An IoT server 110 may obtain the object-related information on the pet obtained from a user terminal (e.g., a smartphone 120). For example, the object-related information may include the breed, age, gender, and weight information of the pet. Based on the breed, age, gender, and weight information of the pet, a 3D shape of the pet may be predicted. Based on the predicted shape of the pet, the avatar mesh 700 may be generated.

Based on object image information for the pet, an avatar 750 to which texture information is applied may be generated. The object image information may include at least one of first image information and second image information described above through FIGS. 1 to 6. The IoT server 110 may generate the texture information based on the image information. The IoT server 110 may generate texture information for the avatar 750 corresponding to the pet. The IoT server 110 may generate the avatar 750 by applying the texture information to the avatar mesh 700.

For example, the IoT server 110 may obtain image information (i.e., second image information) on the pet from an IoT device (e.g., a robot cleaner 130). The image information may include information related to a texture such as a color of the pet, a pattern of the pet, or a skin of the pet. For example, the IoT server 110 may generate the avatar 750 through only at least one image obtained from the robot cleaner 130. The IoT server 110 may apply features (e.g., color, design, pattern, or texture) identified through at least one image of the second image information, that is, the texture information, to the avatar mesh 700. For another example, the IoT server 110 may generate the avatar 750 by combining at least one image obtained from the robot cleaner 130 and at least one image (e.g., the first image information) obtained from the smartphone 120. The IoT server 110 may generate the texture information (e.g., color, design, pattern, or texture) for the object by combining features identified through at least one image of the first image information and features identified through at least one image of the second image information. The IoT server 110 may apply the generated texture information to the avatar mesh 700.

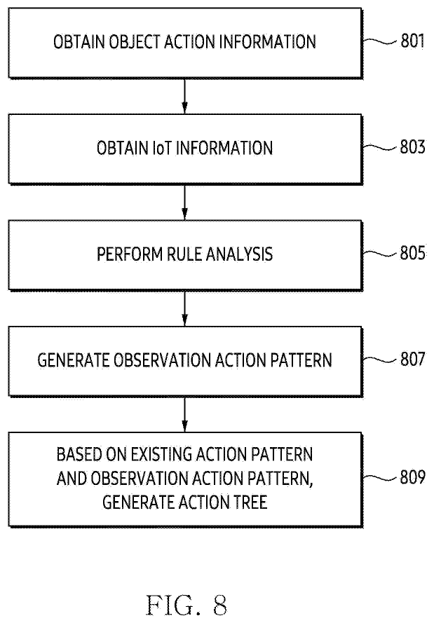

FIG. 8 illustrates an operation flow of an IoT server (e.g., an IoT server 110) for generating an action tree of a pet avatar, according to an embodiment. The motion of the pet in a real space may be reflected as the motion of an avatar in a virtual space. For real-time reflection, the action tree of the pet may be generated.

Referring to FIG. 8, in operation 801, the IoT server 110 may obtain object action information. The IoT server 110 may obtain the object action information from the robot cleaner 130. The object action information may include data on the action of the pet recognized by the robot cleaner 130. For example, the object action information may include information on the position change of the pet. In addition, for example, the object action information may include information on the barking of the pet. In addition, for example, the object action information may include information on the pet's sleep time. In addition, for example, the object action information may include information on the pet's meal. In addition, for example, the object action information may include the pet's tail wagging.

In operation 803, the IoT server 110 may obtain IoT information. The IoT information may mean information collected from each IoT device of one or more IoT devices connected to the IoT server 110. For example, the IoT information may include whether or not a user terminal such as a smartphone 120 exists. For example, the IoT information may include whether a television (TV) in the user's home is turned on or off. In addition, for example, the IoT information may include whether or not the Pet TV is played. In addition, for example, the IoT information may include whether the lighting is turned on or off. In addition, for example, the IoT information may include whether the washing machine is turned on or off. In addition, for example, the IoT information may include information on an internal temperature measured by an air conditioner or an air purifier.

At operation 805, the IoT server 110 may perform rule analysis. The IoT server 110 may perform the rule analysis based on the object action information and the IoT information. For example, in case that a consistent action of the pet is detected in response to a data pattern of the IoT information, the IoT server 110 may associate the data pattern with the action as a rule.

According to an embodiment, an input and an output may be defined for the rule analysis. The input may be a ‘condition’ and the output may be an ‘action’. For example, the rule analysis may be performed in the following manner. The object action information may be referred to as ‘action’. Time information and the IoT information may be referred to as ‘condition’. The IoT server 110 may calculate parameters as shown in the following table.

TABLE 1

| parameter | explanation |
|---|---|
| delay | Average value of time difference between |
| | Condition and Action |
| n_all | Total number of sequence sets |
| n_x | The number of times Condition occurred |
| n_y | The number of times Action occurred |
| n_ptns | The number of times Condition and Action |
| (n_xy) | occurred together |
| confidence | n_ptns ÷ n_x |

The larger the ‘confidence’ parameter, the higher the frequency of performing a specific action according to a specific condition, so the ‘confidence’ parameter may be used as a measure to indicate the association between the specific condition and the specific action.

An action pattern may be analyzed based on the parameters according to Table 1. For example, parameters may be calculated for each condition as follows.

TABLE 2

| location | Time | | | | Same | | | | | | | |
|---|---|---|---|---|---|---|---|---|---|---|---|---|
| ID | interval | | Condition | Action | device | delay | | n_all | n_x | n_y | n_ptns | confidence |
| #1 | 5 | min | 16:10 | barking | — | — | | 4032 | 14 | 40 | 9 | 0.64 |
| #1 | 15 | min | 16:15 | barking | — | — | | 1344 | 14 | 38 | 9 | 0.64 |
| #1 | 30 | min | 16:00 | barking | — | — | | 672 | 14 | 35 | 10 | 0.71 |
| #1 | 5 | min | 16:30 | sleep | — | — | | 4032 | 14 | 30 | 3 | 0.21 |
| #1 | 15 | min | 16:30 | sleep | — | — | | 1344 | 14 | 27 | 4 | 0.29 |
| #1 | 30 | min | 16:30 | sleep | — | — | | 672 | 14 | 24 | 8 | 0.57 |
| #1 | 5 | min | 16:10 + TV_1_ON | position fixed | 1 | 2 | min | 4032 | 9 | 50 | 3 | 0.33 |
| #1 | 15 | min | 16:15 + TV_1_ON | position fixed | 1 | 2 | min | 1344 | 9 | 40 | 3 | 0.33 |
| #1 | 30 | min | 16:00 + TV_1_ON | position fixed | 1 | 3 | min | 672 | 10 | 35 | 3 | 0.30 |
| #1 | 15 | min | 16:00 + Mobile_0_present | Moving to the | 0 | 7 | min | 1344 | 7 | 38 | 6 | 0.86 |
| | | | | front door | | | | | | | | |
| #1 | 30 | min | 16:00 + Mobile_0_present | Moving to the | 0 | 9 | min | 672 | 10 | 35 | 8 | 0.80 |
| | | | | front door | | | | | | | | |
| #1 | 30 | min | 16:00 + Mobile_0_present | sleep | 0 | 20 | min | 672 | 10 | 27 | 3 | 0.30 |
| #1 | 30 | min | 16:00 + TV_1_ON | sleep | 0 | 10 | min | 672 | 10 | 24 | 7 | 0.70 |
| #1 | 15 | min | Mobiel_0_present | barking | 0 | 7 | min | 1344 | 22 | 38 | 14 | 0.64 |
| #1 | 30 | min | Mobiel_0_present | barking | 0 | 10 | min | 672 | 20 | 35 | 17 | 0.85 |
| #1 | 30 | min | Mobiel_0_present | sleep | 0 | 20 | min | 672 | 20 | 24 | 10 | 0.50 |
| #1 | 30 | min | TV_1_on | sleep | 0 | 10 | min | 672 | 38 | 24 | 15 | 0.39 |

For example, the ‘location ID’ may be identification information on a house where the pet is located. The ‘time interval’ may be a time interval for measuring the pet's action. The ‘Same device’ may indicate whether operations for executing a condition are performed on the same device.

In operation 807, the IoT server 110 may generate an observation action pattern. The IoT server 110 may identify an action pattern having a high correlation between ‘action’ and ‘condition’ based on the results of rule analysis. For example, if the ‘confidence’ value is measured high in Table 2, the IoT server 110 may determine that the ‘action’ and ‘condition’ corresponding to the ‘confidence’ value are related to each other. The IoT server 110 may generate an observation action pattern corresponding to a relationship between the ‘action’ and the ‘condition’. For example, an observation action pattern such as “the pet fixes its position in case that the pet TV is turned on” or “the pet moves to the front door when the user's user terminal appears”.

In operation 809, the IoT server 110 may generate an action tree based on a default action pattern and the observation action pattern. The IoT server 110 may generate an action tree for the pet by combining the default action pattern and the observation action pattern. The default action pattern may basically include a pattern input by the user or a producer. For example, in case that a user avatar moves, the pattern in which the pet avatar follows the user avatar may be the default action pattern. In addition, for example, in case that the user avatar feeds, that the pet avatar wags its tail may be the default action pattern. In case of combining the observation action pattern and the default action pattern, the IoT server 110 may determine whether there is no action pattern that contradicts each other. When a contradictory action pattern is detected, the IoT server 110 may delete the default action pattern. For example, in case that the default action pattern is “in case that the user avatar feeds, the pet avatar wags its tail”, but the observation action pattern is “in case that the user feeds, the pet barks”, actions may be different and contradict each other for the same condition. In this case, the IoT server 110 may delete the default action pattern that contradicts the observation action pattern. Accordingly, the contradiction may not occur in the action tree of the pet.

Although it has been described in FIG. 8 that, the action analysis is performed by the IoT server 110 and the action pattern is generated, embodiments of the present disclosure are not limited thereto. The IoT server 110 simply collects the IoT information and the object action information, and the rule analysis (e.g., the operation 805) and the pattern and tree generation operations (e.g., the operations 807 and 809) using the IoT information and the object action information may be performed by an external electronic device. In order to lower the computational burden of the IoT server 110, the IoT server 110 may provide the IoT information and the object action information to the external electronic device for the rule analysis and the pattern and tree generation. Thereafter, the IoT server 110 may receive information on the observation action pattern and the action tree from the external electronic device.

When the observation action pattern in FIG. 8 is generated, the IoT server 110 may transmit the information on the observation action pattern to the pet's user terminal (e.g., the smartphone 120). The user of the smartphone 120 may check the action pattern set to the pet avatar before generating the pet avatar. In addition, the IoT server 110 may transmit information on the observation action pattern to a metaverse server 140. According to the information on the observation action pattern, the metaverse server 140 may display the pet avatar so that the pet avatar in the virtual space of the metaverse acts. For example, the observation action pattern may be “barking when the TV is turned on”. The metaverse server 140 may provide rendering information to the metaverse terminal 150 so that the pet avatar in the virtual space does barking action when the input of the user (e.g., the metaverse terminal 150) who turns on the TV in the virtual space is detected.

When the action tree in FIG. 8 is generated, the IoT server 110 may transmit information on the generated action tree to the user terminal (e.g., the smartphone 120) of the pet. In addition, the IoT server 110 may transmit an action tree including a plurality of action patterns to the metaverse server 140, similarly to the observation action pattern. The metaverse server 140 may display the pet avatar so that the pet avatar in the virtual space of the metaverse acts according to the information on the action pattern of the action tree.

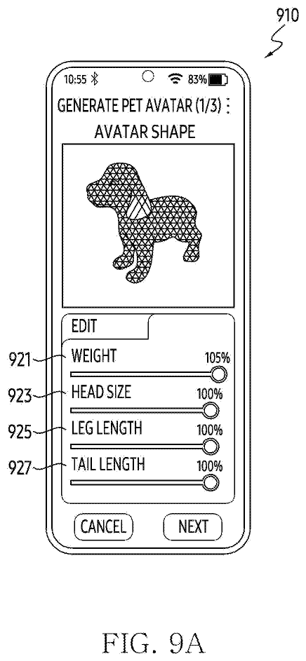

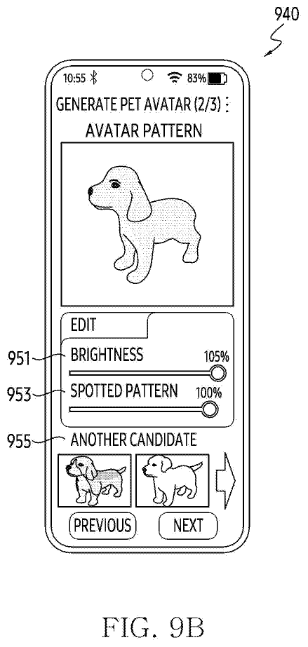

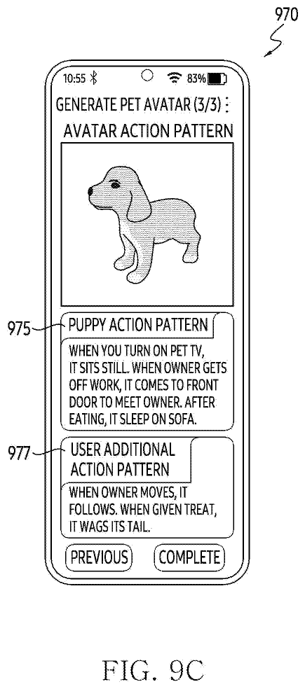

In FIGS. 1 to 8, an example in which the avatar is displayed and acts in the virtual space of the metaverse by generating avatar information based on the data collected by the IoT device 110 and delivering the generated avatar information to the metaverse server 140 has been described. Meanwhile, the display and action of the avatar may be controlled by the user's input as described above, but may also be controlled by another device (e.g., the robot cleaner 130). In addition, for matching the real space and the virtual space, the display and action of the avatar may be shared with the user of the electronic device (e.g., the smartphone 120) for the object (e.g., user, pet) in the real space. Hereinafter, an example in which the information on the avatar in the virtual space is displayed on a user's screen will be described, through FIGS. 9A to 9C.

FIGS. 9A to 9C illustrate an example of a user interface for generating a pet avatar. The user interface may be displayed on an electronic device (e.g., a smartphone 120) of a user of a pet.

Referring to FIG. 9A, the smartphone 120 may display a user interface 910 through a display (e.g., a display unit 123). The user interface 910 may include various items for determining an avatar shape. For example, the user interface 910 may include an item 921 for inputting the pet's weight. For example, the user interface 910 may include an item 923 for inputting the pet's head size. For example, the user interface 910 may include an item 925 for inputting the pet's leg length. For example, the user interface 910 may include an item 927 for inputting the pet's tail length. According to an embodiment, object-related information for the pet may be generated based on items inputted through the user interface 910. The smartphone 120 may transmit object-related information including the items to the IoT server 110.

Referring to FIG. 9B, the smartphone 120 may display a user interface 940 through the display (e.g., the display unit 123). The user interface 940 may include various items for determining an avatar pattern. For example, the user interface 940 may include an item 951 for inputting the pet's brightness. For example, the user interface 940 may include an item 953 for inputting the degree of the spotted pattern. For example, the user interface 940 may include an item 955 for providing the predefined pattern. According to an embodiment, the IoT server 110 may transmit contents about applied texture information to the smartphone 120 based on object image information (e.g., first image information obtained through the smartphone 120 and second image information obtained through a robot cleaner 130). The user of the smartphone 120 may identify the brightness and pattern extracted to correspond to the pet in a real space. For example, in order to reduce the difference between the real space and a virtual space, the user may adjust the brightness and the pattern through the user interface 940. In addition, for example, the user may adjust the brightness and the pattern through the user interface 940 so that the pet avatar in the virtual space has different features (e.g., different brightness, different pattern) from the pet in the real space. Additionally, according to an embodiment, object-related information for the pet may be generated based on items inputted through the user interface 940. The smartphone 120 may transmit object-related information including the items to the IoT server 110.

Referring to FIG. 9C, the smartphone 120 may display a user interface 970 through the display (e.g., the display unit 123). The user interface 970 may include various items for indicating an avatar action pattern. For example, the user interface 970 may include an item 975 indicating a puppy pattern. For example, the user interface 970 may include an item 977 indicating an action pattern related to the user. According to an embodiment, the IoT server 110 may transmit contents about the action pattern analyzed from the action information of the robot cleaner 130 to the smartphone 120. The IoT server 110 may provide a more immersive pet experience in the virtual space of the metaverse by notifying the user of the action pattern of the pet avatar in advance.

In embodiments, a server 110 for managing electronic devices is provided. The server 110 may comprise memory (e.g., storage unit 113), a transceiver (e.g., a communication unit 111), and at least one processor (e.g., a control unit 112) coupled to the memory and the transceiver. The at least one processor may be configured to obtain first image information for an object from an electronic device (e.g., smartphone 120). The at least one processor may be configured to obtain second image information for the object from a robot cleaner 130 among the electronic devices. The at least one processor may be configured to generate avatar information for displaying an avatar of the object in a virtual space of a metaverse, based on the first image information and the second image information. The at least one processor may be configured to transmit the avatar information to a metaverse server 140 for providing the virtual space of the metaverse.

According to an embodiment, the at least one processor may be configured to receive action information of the object from the robot cleaner 130. The at least one processor may be configured to generate update information for updating the avatar information based on the action information. The at least one processor may be configured to transmit the avatar information to the metaverse server 140.

According to an embodiment, the at least one processor may be, to generate the avatar information, configured to obtain prior information of the object. The at least one processor may be, to generate the avatar information, configured to generate an avatar mesh corresponding to an appearance of the object based on the prior information. The at least one processor may be, to generate the avatar information, configured to generate texture information for the object based on the first image information and the second image information. The at least one processor may be, to generate the avatar information, configured to generate the avatar information by applying the texture information to the avatar mesh.

According to an embodiment, the prior information may comprise at least one of age, height, weight, gender, name, or type. The prior information may be received from the electronic device 120.

According to an embodiment, the first image information may comprise at least one first image obtained by capturing a first area of the object. The second image information may comprise at least one second image obtained by capturing a second area of the object. With respect to the object, a position of the first area may be higher than a position of the second area.

According to an embodiment, the at least one processor, to generate the avatar information, may be configured to generate first avatar information corresponding to the first area based on the at least one first image. The at least one processor, to generate the avatar information, may be configured to generate second avatar information corresponding to the second area based on the at least one second image. The at least one processor, to generate the avatar information, may be configured to generate third avatar information corresponding to a third area where the first area and the second area overlap, based on the at least one first image and the at least one second image. The third avatar information may be determined based on a first weight to be applied to the at least one first image and a second weight to be applied to the at least one second image. The second weight may be set to be greater than the first weight.

According to an embodiment, the at least one second image may comprise an image obtained by capturing the object at each position of a plurality of positions of the robot cleaner 130, with the object as a center. According to an embodiment, the at least one processor may be configured to obtain object action information for the object from the robot cleaner 130. The at least one processor may be configured to obtain internet of things (IOT) information from at least one electronic device among the electronic devices. The at least one processor may be configured to generate an observed action pattern of the object by performing a rule analysis based on the object action information and the IoT information. The at least one processor may be configured to generate an action tree of the object based on the observed action pattern.

According to an embodiment, the at least one processor may be, to generate the observed action pattern, configured to generate condition information based on time information and the IoT information. The at least one processor may be, to generate the observed action pattern, configured to identify a specific action having a ratio greater than or equal to a threshold value in the condition information, based on the object action information. The at least one processor may be, to generate the observed action pattern, configured to generate the observed action pattern by associating the condition information and the specific action.

According to an embodiment, the at least one processor may be configured to transmit, to the metaverse server 140, information for the action tree. The at least one processor may be configured to transmit, to the electronic device 120, the information for the action tree.

In embodiments, a server may include memory storing instructions and at least one processor configured to execute the instructions to obtain first image information for an object from an electronic device, obtain second image information for the object from a robot cleaner, generate avatar information for displaying an avatar of the object in a virtual space of a metaverse, based on the first image information and the second image information, and transmit the avatar information to a metaverse server for providing the virtual space of the metaverse.

According to an embodiment, the at least one processor is further configured to execute the instructions to receive action information of the object from the robot cleaner, generate update information for updating the avatar information based on the action information, and transmit the update information to the metaverse server.

According to an embodiment, to generate the avatar information, the at least one processor is configured to execute the instructions to obtain prior information of the object, generate an avatar mesh corresponding to an appearance of the object based on the prior information, generate texture information for the object based on the first image information and the second image information, and generate the avatar information by applying the texture information to the avatar mesh.

According to an embodiment, the prior information comprises at least one of age, height, weight, gender, name, or type. The prior information is received from the electronic device.

According to an embodiment, the first image information comprises at least one first image obtained by capturing a first area of the object. The second image information comprises at least one second image obtained by capturing a second area of the object. With respect to the object, a position of the first area is higher than a position of the second area.

According to an embodiment, to generate the avatar information, the at least one processor is configured to execute the instructions to generate first avatar information corresponding to the first area based on the at least one first image, generate second avatar information corresponding to the second area based on the at least one second image, and generate third avatar information corresponding to a third area where the first area and the second area overlap, based on the at least one first image and the at least one second image. The third avatar information is determined based on a first weight to be applied to the at least one first image and a second weight to be applied to the at least one second image. The second weight is set to be greater than the first weight.

According to an embodiment, the at least one second image comprises an image obtained by capturing the object at each position of a plurality of positions of the robot cleaner, with the object as a center.

According to an embodiment, the at least one processor is further configured to execute the instructions to obtain object action information for the object from the robot cleaner, obtain internet of things (IOT) information from at least one electronic device among electronic devices managed by the server, generate an observed action pattern of the object by performing a rule analysis based on the object action information and the IoT information, and generate an action tree of the object based on the observed action pattern.

According to an embodiment, the at least one processor is, to generate the observed action pattern, configured to execute the instructions to generate condition information based on time information and the IoT information, identify a specific action having a ratio greater than or equal to a threshold value in the condition information, based on the object action information, and generate the observed action pattern by associating the condition information and the specific action.

According to an embodiment, the at least one processor is further configured to execute the instructions to transmit, to the metaverse server, information for the action tree, and transmit, to the electronic device, the information for the action tree.

In embodiments, a method performed by a server 110 for managing electronic devices is provided. The method may comprise obtaining first image information for an object from an electronic device 120. The method may comprise obtaining second image information for the object from a robot cleaner 130 among the electronic devices. The method may comprise generating avatar information for displaying an avatar of the object in a virtual space of a metaverse, based on the first image information and the second image information. The method may comprise transmitting the avatar information to a metaverse server 140 for providing the virtual space of the metaverse.

According to an embodiment, the method may comprise receiving action information of the object from the robot cleaner 130. The method may comprise generating update information for updating the avatar information based on the action information. The method may comprise transmitting the avatar information to the metaverse server 140.

According to an embodiment, the generating of the avatar information may comprise obtaining prior information of the object. The generating of the avatar information may comprise generating an avatar mesh corresponding to an appearance of the object based on the prior information. The generating of the avatar information may comprise generating texture information for the object based on the first image information and the second image information. The generating of the avatar information may comprise generating the avatar information by applying the texture information to the avatar mesh.

According to an embodiment, the prior information may comprise at least one of age, height, weight, gender, name, or type. The prior information may be received from the electronic device 120.

According to an embodiment, the first image information may comprise at least one first image obtained by capturing a first area of the object. The second image information may comprise at least one second image obtained by capturing a second area of the object. With respect to the object, a position of the first area may be higher than a position of the second area.

According to an embodiment, the generating of the avatar information may comprise generating first avatar information corresponding to the first area based on the at least one first image. The generating of the avatar information may comprise generating second avatar information corresponding to the second area based on the at least one second image. The generating of the avatar information may comprise generating third avatar information corresponding to a third area where the first area and the second area overlap, based on the at least one first image and the at least one second image. The third avatar information may be determined based on a first weight to be applied to the at least one first image and a second weight to be applied to the at least one second image. The second weight may be set to be greater than the first weight.

According to an embodiment, the at least one second image may comprise an image obtained by capturing the object at each position of a plurality of positions of the robot cleaner 130, with the object as a center.

According to an embodiment, the method may comprise obtaining object action information for the object from the robot cleaner 130. The method may comprise obtaining internet of things (IOT) information from at least one electronic device among the electronic devices. The method may comprise generating an observed action pattern of the object by performing a rule analysis based on the object action information and the IoT information. The method may comprise generating an action tree of the object based on the observed action pattern.

According to an embodiment, the generating of the observed action pattern may comprise generating condition information based on time information and the IoT information. The generating of the observed action pattern may comprise identifying a specific action having a ratio greater than or equal to a threshold value in the condition information, based on the object action information. The generating of the observed action pattern may comprise generating the observed action pattern by associating the condition information and the specific action.

According to an embodiment, the method may comprise transmitting, to the metaverse server 140, information for the action tree. The method may comprise transmitting, to the electronic device 120, the information for the action tree.

In embodiments, a method performed by a server may include obtaining first image information for an object from an electronic device, obtaining second image information for the object from a robot cleaner, generating avatar information for displaying an avatar of the object in a virtual space of a metaverse, based on the first image information and the second image information, and transmitting the avatar information to a metaverse server for providing the virtual space of the metaverse.

In embodiments, a non-transitory storage medium is provided. The non-transitory storage medium may include memory configured to store instructions. The instructions cause, when executed by at least one processor, a server to obtain first image information for an object from an electronic device, obtain second image information for the object from a robot cleaner, generate avatar information for displaying an avatar of the object in a virtual space of a metaverse, based on the first image information and the second image information, and transmit the avatar information to a metaverse server for providing the virtual space of the metaverse.

The device described above may be implemented as a hardware component, a software component, and/or a combination of a hardware component and a software component. For example, the devices and components described in the embodiments may be implemented by using one or more general purpose computers or special purpose computers, such as a processor, controller, arithmetic logic unit (ALU), digital signal processor, microcomputer, field programmable gate array (FPGA), programmable logic unit (PLU), microprocessor, or any other device capable of executing and responding to instructions. The processing device may perform an operating system (OS) and one or more software applications executed on the operating system. In addition, the processing device may access, store, manipulate, process, and generate data in response to the execution of the software. For convenience of understanding, there is a case that one processing device is described as being used, but a person who has ordinary knowledge in the relevant technical field may see that the processing device may include a plurality of processing elements and/or a plurality of types of processing elements. For example, the processing device may include a plurality of processors or one processor and one controller. In addition, another processing configuration, such as a parallel processor, is also possible.

The software may include a computer program, code, instruction, or a combination of one or more thereof, and may configure the processing device to operate as desired or may command the processing device independently or collectively. The software and/or data may be embodied in any type of machine, component, physical device, computer storage medium, or device, to be interpreted by the processing device or to provide commands or data to the processing device. The software may be distributed on network-connected computer systems and stored or executed in a distributed manner. The software and data may be stored in one or more computer-readable recording medium.

The method according to the embodiment may be implemented in the form of a program command that may be performed through various computer means and recorded on a computer-readable medium. In this case, the medium may continuously store a program executable by the computer or may temporarily store the program for execution or download. In addition, the medium may be various recording means or storage means in the form of a single or a combination of several hardware, but is not limited to a medium directly connected to a certain computer system, and may exist distributed on the network. Examples of media may include a magnetic medium such as a hard disk, floppy disk, and magnetic tape, optical recording medium such as a CD-ROM and DVD, magneto-optical medium such as a floptical disk, and those configured to store program instructions, including ROM, RAM, flash memory, and the like. In addition, examples of other media may include recording media or storage media managed by app stores that distribute applications, sites that supply or distribute various software, servers, and the like.

As described above, although the embodiments have been described with limited examples and drawings, a person who has ordinary knowledge in the relevant technical field is capable of various modifications and transform from the above description. For example, even if the described technologies are performed in a different order from the described method, and/or the components of the described system, structure, device, circuit, and the like are coupled or combined in a different form from the described method, or replaced or substituted by other components or equivalents, appropriate a result may be achieved.

Therefore, other implementations, other embodiments, and those equivalent to the scope of the claims are in the scope of the claims described later.

What is claimed is:

1. A server comprising:
memory storing instructions; and
at least one processor configured to execute the instructions to:
obtain first image information for an object from an electronic device,
obtain second image information for the object from a robot cleaner,
generate avatar information for displaying an avatar of the object in a virtual space of a metaverse, based on the first image information and the second image information, and
transmit the avatar information to a metaverse server for providing the virtual space of the metaverse.

2. The server of claim 1, wherein the at least one processor is further configured to execute the instructions to:
receive action information of the object from the robot cleaner,
generate update information for updating the avatar information based on the action information, and
transmit the update information to the metaverse server.

3. The server of claim 1, wherein, to generate the avatar information, the at least one processor is configured to execute the instructions to:
obtain prior information of the object,
generate an avatar mesh corresponding to an appearance of the object based on the prior information,
generate texture information for the object based on the first image information and the second image information, and
generate the avatar information by applying the texture information to the avatar mesh.

4. The server of claim 3, wherein
the prior information comprises at least one of age, height, weight, gender, name, or type, and
the prior information is received from the electronic device.

5. The server of claim 1, wherein
the first image information comprises at least one first image obtained by capturing a first area of the object,
the second image information comprises at least one second image obtained by capturing a second area of the object, and,
with respect to the object, a position of the first area is higher than a position of the second area.

6. The server of claim 5, wherein, to generate the avatar information, the at least one processor is configured to execute the instructions to:
generate first avatar information corresponding to the first area based on the at least one first image,
generate second avatar information corresponding to the second area based on the at least one second image, and
generate third avatar information corresponding to a third area where the first area and the second area overlap, based on the at least one first image and the at least one second image,
wherein the third avatar information is determined based on a first weight to be applied to the at least one first image and a second weight to be applied to the at least one second image, and
wherein the second weight is set to be greater than the first weight.

7. The server of claim 5,
wherein the at least one second image comprises an image obtained by capturing the object at each position of a plurality of positions of the robot cleaner, with the object as a center.

8. The server of claim 1, wherein the at least one processor is further configured to execute the instructions to:
obtain object action information for the object from the robot cleaner,
obtain internet of things (IOT) information from at least one electronic device among electronic devices managed by the server;
generate an observed action pattern of the object by performing a rule analysis based on the object action information and the IoT information; and
generate an action tree of the object based on the observed action pattern.

9. The server of claim 8,
wherein the at least one processor is, to generate the observed action pattern, configured to execute the instructions to:
generate condition information based on time information and the IoT information,
identify a specific action having a ratio greater than or equal to a threshold value in the condition information, based on the object action information, and
generate the observed action pattern by associating the condition information and the specific action.

10. The server of claim 8, wherein the at least one processor is further configured to execute the instructions to:
transmit, to the metaverse server, information for the action tree, and
transmit, to the electronic device, the information for the action tree.

11. A method performed by a server, comprising:
obtaining first image information for an object from an electronic device;
obtaining second image information for the object from a robot cleaner;
generating avatar information for displaying an avatar of the object in a virtual space of a metaverse, based on the first image information and the second image information; and
transmitting the avatar information to a metaverse server for providing the virtual space of the metaverse.

12. The method of claim 11, further comprising:
receiving action information of the object from the robot cleaner;
generating update information for updating the avatar information based on the action information; and
transmitting the update information to the metaverse server.

13. The method of claim 11, wherein the generating of the avatar information, comprises:
obtaining prior information of the object;
generating an avatar mesh corresponding to an appearance of the object based on the prior information;
generating texture information for the object based on the first image information and the second image information; and
generating the avatar information by applying the texture information to the avatar mesh.

14. The method of claim 13,
wherein the prior information comprises at least one of age, height, weight, gender, name, or type, and
wherein the prior information is received from the electronic device,

15. The method of claim 11,
wherein the first image information comprises at least one first image obtained by capturing a first area of the object,
wherein the second image information comprises at least one second image obtained by capturing a second area of the object, and
wherein, with respect to the object, a position of the first area is higher than a position of the second area.

16. The method of claim 15, wherein the generating of the avatar information, comprises:
generating first avatar information corresponding to the first area based on the at least one first image;
generating second avatar information corresponding to the second area based on the at least one second image; and
generating third avatar information corresponding to a third area where the first area and the second area overlap, based on the at least one first image and the at least one second image,
wherein the third avatar information is determined based on a first weight to be applied to the at least one first image and a second weight to be applied to the at least one second image, and
wherein the second weight is set to be greater than the first weight.

17. The method of claim 15,
wherein the at least one second image comprises an image obtained by capturing the object at each position of a plurality of positions of the robot cleaner, with the object as a center.

18. The method of claim 11, further comprising:
obtaining object action information for the object from the robot cleaner;
obtaining internet of things (IOT) information from at least one electronic device among electronic devices managed by the server;
generating an observed action pattern of the object by performing a rule analysis based on the object action information and the IoT information; and
generating an action tree of the object based on the observed action pattern.

19. The method of claim 18,
wherein the generating of the observed action pattern comprises:
generating condition information based on time information and the IoT information;
identifying a specific action having a ratio greater than or equal to a threshold value in the condition information, based on the object action information; and
generating the observed action pattern by associating the condition information and the specific action.

20. A non-transitory storage medium,
memory configured to store instructions,
wherein the instructions cause, when executed by at least one processor, a server to:
obtain first image information for an object from an electronic device,
obtain second image information for the object from a robot cleaner,
generate avatar information for displaying an avatar of the object in a virtual space of a metaverse, based on the first image information and the second image information, and
transmit the avatar information to a metaverse server for providing the virtual space of the metaverse.
